(19) United States
(12) Patent Application Publication
(10) Pub. No.: US 2007/0025041 A1
(43) Pub. Date: Feb. 1, 2007

(54) Power failure detection circuit of swithching source

(75) Inventor: Kazuaki Nakayama, Tokyo (JP)

Correspondence Address: DRINKER BIDDLE & REATH (DC), 1500 K STREET, N.W., SUITE 1100, WASHINGTON, DC, 20005-1209, US

(73) Assignee: PIONEER CORPORATION

(21) Appl. No.: 11/493,852

(22) Filed: Jul. 27, 2006

(30) Foreign Application Priority Data
Jul. 29, 2005 (JP) P2005-221418

(51) Int. Cl. H02H 3/24

(52) U.S. Cl. 361/92

(57) ABSTRACT

A power failure detection circuit of a switching source includes: a switching element; a control circuit of the switching element, and a photocoupler. The phtocoupler includes a light emitting diode and a phototransistor. The light emitting diode is located at a primary side of a transformer and is serially connected to the control circuit. A cathode of the light emitting diode is connected to a capacitor. The phototransistor for detecting a power failure of an alternating current source is located at a secondary side of the transformer. A charging current flowing into the capacitor is used as a detection current for detecting the power failure of the alternate current source.

### CROSS-REFERENCE TO RELATED APPLICATIONS

This application is based on and claims the benefit of priority from the prior Japanese Patent Application No. 2005-221418, filed on Jul. 29, 2006; the entire contents of which are incorporated herein by reference.

### BACKGROUND

1. Technical Field

The present invention relates to a power failure detection circuit of a switching source.

2. Description of Related Art

A power failure detection circuit which employs a photocoupler is frequently used for a switching source of electronic devices such as devices having a microcomputer (for example, refer to JP-A-2002-17084).

FIG. 1 shows an example of a related-art power failure detection circuit of a switching source.

As shown in FIG. 1, a power failure detection circuit 101 of the switching source includes a photocoupler PC having a light emitting diode D₁ at a primary side of a transformer T and a phototransistor Q₁ at a secondary side of the transformer T.

At the primary side of the transformer T, cathodes of diodes Dp₃ and Dp₄ of a bridge rectifier (includes diodes Dp₃, Dp₄, Dp₅, and Dp₆) for aligning polarity of an alternating-current (AC) source in one direction are connected to one end of a resistor R₁, respectively, and the other end of the resistor R₁ is connected to an anode of a light emitting diode D₁.

On the other hand, outputs of rectifier diodes Dp₁ and Dp₂ are connected to one end of a primary winding wire of the transformer T, and the other end of the primary winding wire of the transformer T is connected to a transistor Q₂ that is a switching element. In addition, the outputs of the rectifier diodes Dp₁ and Dp₂ are connected to an input terminal of a control circuit 2 for controlling on/off of the transistor Q₂ that is a switching element, via a resistor R₂. A capacitor Cp is an electrolytic capacitor for smoothing a current.

In addition, one end of a secondary winding wire of the transformer T is connected to an anode of a diode D₂. A cathode of the diode D₂ is connected to an output terminal of an output voltage V₀, an electrolytic capacitor C₂, and a resistor R₃, respectively. The other end of the resistor R₃ is connected to a detected output voltage V₃ and a collector of the phototransistor Q₁, respectively. The other end of the secondary winding wire of the transformer T is connected to the ground potential.

### SUMMARY

A related-art power failure detection circuit, however, detects a power failure by converting a pulse of a detection output voltage V₃ into a direct current (DC) voltage and outputting the DC voltage to (an input circuit of) the electronic device having a switching source. In addition, a starting resistor R₂ for start-up is needed for the switching source, and therefore power loss occurs in the switching source and the power failure detection circuit.

In order to accurately detect the power failure of the AC source, a sufficiently high current is needed as a current i₁ to flow into the resistor R₁. For example, when it is assumed that a peak value of the current i₁ is 1 mA and V_{AC}=100 Vᵣₘₛ, R₁=140 KΩ is needed, and the power loss P₁ is P₁=V_{AC}²/R₁=71 mW.

On the other hand, since a starting current of a control circuit 2 is generally about 0.4 mA, the starting resistor R₂ is 350 kΩ, and the power loss in the starting resistor R₂ is P₂=i₂²×R₂=V_{AC}²/R₂=56 mW. Accordingly, a total power loss P is P=P₁+P₂=127 mW. Here, power losses due to a voltage V_{F} of the diode and a source voltage V_{IC} of the control circuit 2 are omitted.

As described above, in the related-art power failure detection circuit of the switching source, since the total power loss is a sum of a power loss in the power failure detection circuit and a power loss in the starting resistor, a standby power is on.

FIG. 2 is a schematic diagram of waveforms of a voltage V₁, the current i₁, and the detection voltage V₃ (when the resistance of the resistor R₁ is greater than that of a resistor R₃ and when the resistance of the resistor R₁ is less than that of the resistor R₃).

As shown in FIG. 2, a waveform of a detected signal is a positive zero-cross-over pulse and mismatches to a conduction angle of the bridge rectifier. That is, since pulse locations of the detected signal are not coincide with the conduction angle of the rectifier bridge in order to detect zero-cross points, the pulse locations are not accurately detected. For example, when a temporary blackout occurs at an alternating current (AC) phase angle of 0° (zero-cross point), even though the pulse is output, the rectifier DC voltage Vcc is already reduced.

The present invention has been made in view of the above circumstances and provides a power failure detection circuit of a switching source. According an aspect of the invention, a power failure detection circuit of a switching source enables more accurate detection for power failure by reducing a total power loss in the power failure detection circuit of the switching source.

According to another aspect of the invention, there is provided a power failure detection circuit of a switching source, comprising: a switching element; a control circuit of the switching element, and a photocoupler comprising; a light emitting diode located at a primary side of a transformer, the light emitting diode being serially connected to the control circuit, a cathode of the light emitting diode being connected to a capacitor; and a phototransistor located at a secondary side of the transformer, for detecting a power failure of an alternating current source. A charging current flowing into the capacitor is used as a detection current for detecting the power failure of the alternate current source.

### BRIEF DESCRIPTION OF THE DRAWINGS

These and other objects and advantages of this invention will become more fully apparent from the following detailed description taken with the accompanying drawings in which:

FIG. 1 is a circuit diagram showing a related-art power failure detection circuit;

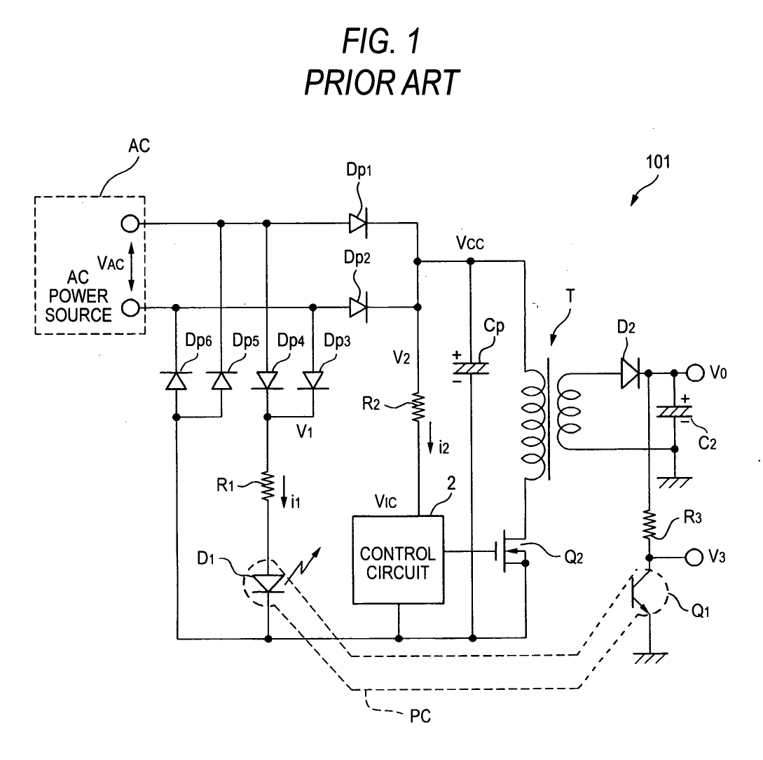

FIG. 2 is a schematic diagram of waveforms of a voltage V1, a current i1, and a detection voltage V3 (when resistance of a resistor R1 is greater than that of a resistor R3 and when the resistance of the resistor R1 is less than that of the resistor R3);

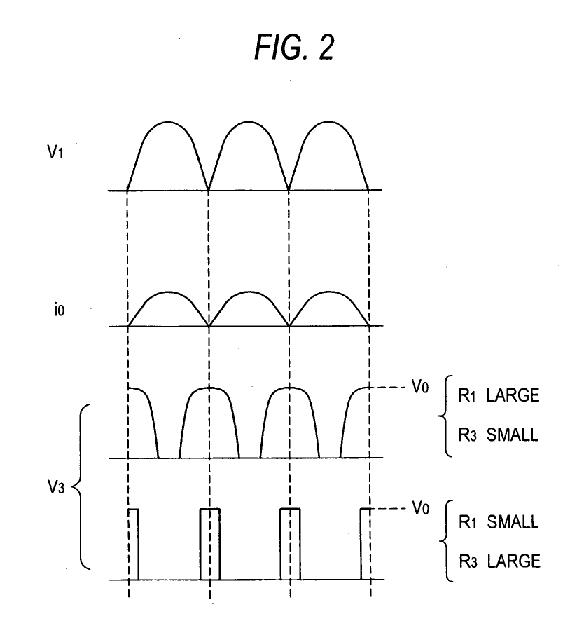

FIG. 3 is a circuit diagram showing a power failure detection circuit according to an embodiment of the invention;

FIG. 4 is a schematic diagram of waveforms of the output voltage V1 (input voltage of the light emitting diode D1) of the bridge rectifier, the current iC1 (≈id1) to flow into the capacitor C1, and detection voltage V3, in the power failure detection circuit of FIG. 3; and

FIG. 5 shows an example of waveforms of values measured at the power failure detection circuit according to the embodiment.

### DESCRIPTION OF THE EMBODIMENTS

Hereinafter, the power failure detection circuit according to an embodiment of the present invention will be described in detail, with reference to the accompanying drawings.

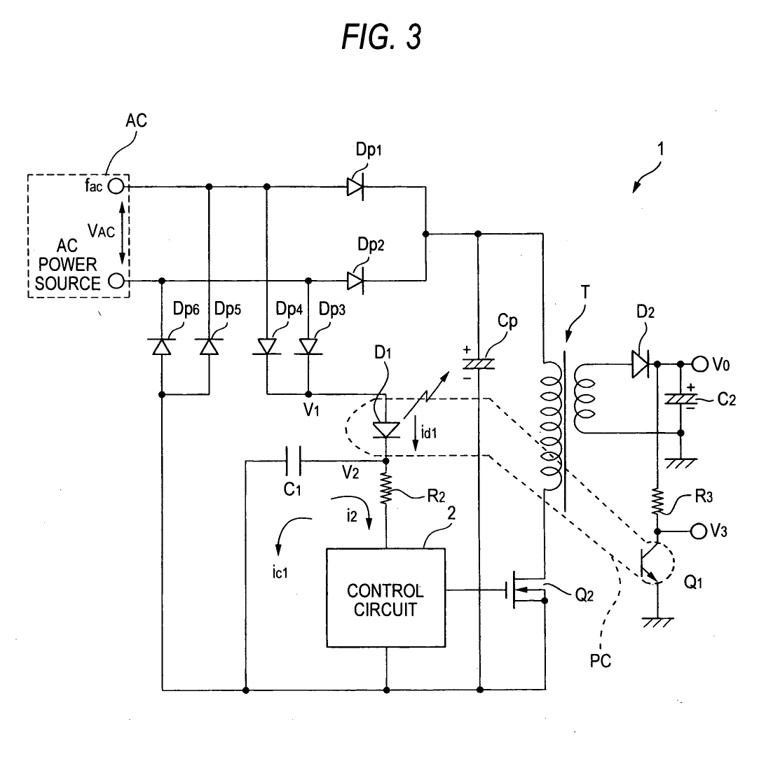

FIG. 3 is a circuit diagram showing a power failure detection circuit according to an embodiment of the present invention.

As shown in FIG. 3, a power failure detection circuit 1 of a switching source includes a photocoupler PC including a light emitting diode D₁ at a primary side of a transformer T and a phototransistor Q₁ at a secondary side.

At the primary side, cathodes of diodes Dp₃ and Dp₄ of a bridge rectifier (includes diodes Dp₃, Dp₄, Dp₅, and Dp₆) which aligns polarity of an alternating-current (AC) source are directly connected to an anode of the light emitting diode D₁, respectively.

Furthermore, a cathode of the light emitting diode D₁ is connected to one end of a resistor R₂, and the other end of the resistor R₂ is connected to an input terminal of a control circuit 2 for controlling a transistor Q₂ that is a switching element.

In addition, the cathode of the light emitting diode D₁ is connected to a capacitor C₁ and is connected to anodes of the diodes Dp₅ and Dp₆ of the rectifier bridge and a source of the transistor Q₂ via the capacitor C₁.

In addition, outputs of the rectifier diode Dp₁ and DP₂ are connected to one end of a primary winding wire of the transformer T, and the other end of the primary winding wire of the transformer T is connected the transistor Q₂ which is the switching element. A capacitor Cp is an electrolytic capacitor for smoothing a current.

In addition, one end of a secondary winding wire of the transformer T is connected to an anode of a diode D₂. A cathode of the diode D₂ is connected to an output terminal of an output voltage V₀, an electrolytic capacitor C₂, and a resistor R₃, respectively. The other end of the resistor R₃ is connected to a detection output voltage V₃ and a collector of a phototransistor Q₁, respectively. The other end of the secondary winding wire of the transformer T is connected to the ground potential.

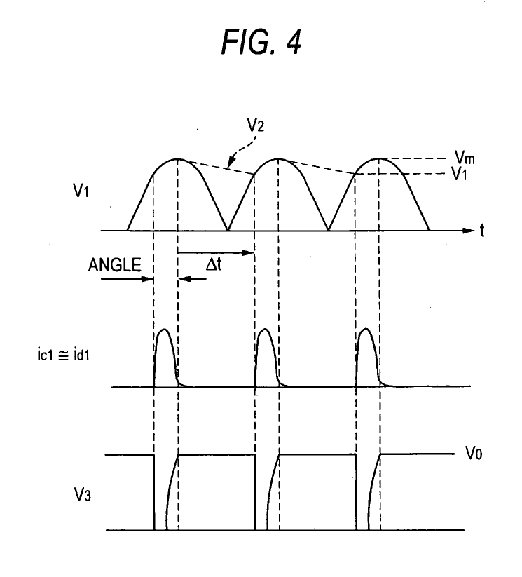

FIG. 4 is a schematic diagram of waveforms of the output voltage V₁ (input voltage of the light emitting diode D₁) of the bridge rectifier, the current i_{c1} (¤i_{d1}) to flow into the capacitor C₁, and detection voltage V₃, in the power failure detection circuit according to an embodiment of the present invention.

A waveform of the detection voltage V₃ shown in FIG. 4 is a negative pulse and coincides with the conduction angle of the bridge rectifier to more accurately detect the power failure.

In FIG. 4, a ripple voltage ΔV₂ of a voltage V₂ is calculated by ΔV₂=Vₘ−V₁. This is calculated as follows.

The capacitor C₁ is determined so that peak values of a charging current i_{c1} are equal to or greater than 1 mA. Experientially, the ripple voltage ΔV₂ is calculated by using equation of C₁×R₂¤1/f_{AC}(f_{AC} is a frequency of an alternating current (AC) source), and for example, when C₁=0.068 μF and R₂=300 kΩ, an interval Δt between zero-crossing points of the voltages V₁ and V₂• is calculated by Equation 1, as follows,
e^{t/CR}=−cos(2πf_{AC}×t) [Equation 1]
where since Δt ¤7.5 ms, V₁=98 V, and the average of the voltage V₂ is calculated by Equation 2.
V̅₂=(\sqrt{2}V_{AC}+V₁)/2≅120V [Equation 2]
Accordingly, the total power loss P is calculated by Equation 3.
P=P₂= V̅₂²/R₂=48 mW [Equation 3]
In addition, a starting current i₂ of a control circuit 2 is calculated by Equation 4.
i₂= V̅₂/R₂=0.4 mA [Equation 4]
Equation 4 is the same as that of the related-art power failure detection circuit.
In addition, peak values of the charging current i_{C1} are nearly same as the peak values of the current i_{d1}, and the current i_{d1} is calculated by Equation 5, as follows,
i_{d1}=C₁×Vₘ×ω_{AC}×sin(ω_{AC}×Δt)=2.1 mA [Equation 5]
where ω_{AC}=2πf_{AC}.

As described above, the current i_{d1} for detecting the power failure is sufficiently high.

Accordingly, total power loss P in the power failure detection circuit according to an embodiment of the present invention becomes about 1/2.6 of that of the related-art power failure detection circuit.

As described above, according to the present embodiment, the total power loss P becomes ½˜⅓ of that of the related-art power failure detection circuit to sharply reduce a standby power. In addition, since a detection time coincides with the conduction angle of the bridge rectifier, it is possible to more accurately detect the power failure.

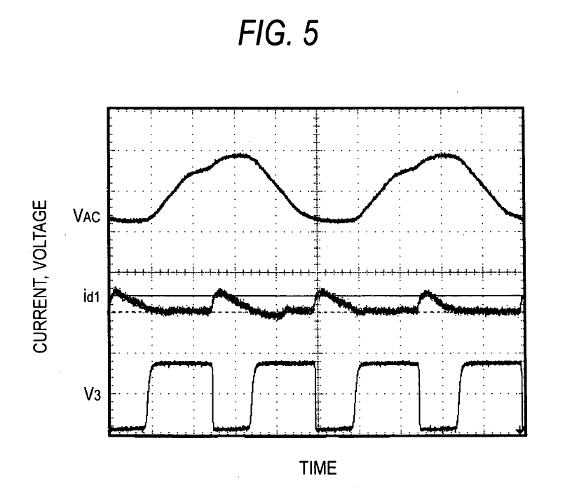

An example of a waveform measured in the power failure detection circuit is shown in FIG. 5. FIG. 5 shows the voltage V_{AC} of the AC source, the current i_{d1} to flow into the light emitting diode D₁, and the detection voltage V₃, respectively, from the top. In this example, the resistance of the starting resistor R₂ is 450 kΩ. As shown in the schematic diagram of FIG. 4, since the waveform of the detection voltage V₃ is a negative pulse and coincides with the conduction angle, it is possible to accurately detect the power failure.

The starting resistor R₂ may be a constant current circuit or constant current element.

In addition, it is possible to replace the diodes Dp₃ and Dp₄ with a series resistor for safety and to replace the diode D₁ with a parallel capacitor for preventing malfunction due to a noise.

According to the present embodiment, the power failure detection circuit 1 includes the photocoupler PC having the light emitting diode D₁ formed at the primary side of the transformer T and the phototransistor Q₁ formed at the secondary side of the transformer T for detecting the power failure of the AC source. In the power failure detection circuit of the switching source, the light emitting diode D₁ is serially connected to the control circuit 2 of the switching element, the cathode of the light emitting diode D₁ is connected to the capacitor C₁, and the charging current to flow into the capacitor C₁ is used as the detection current for detecting the power failure of the AC source.

Thereby, it is possible to obtain the power failure detection circuit capable of more accurately detecting the power failure by reducing the total power loss in the power failure detection circuit of the switching source.

According to the above-embodiment, a power failure detection circuit including a photocoupler having a light emitting diode formed at a primary side of a transformer and a phototransistor formed at a secondary side of the transformer for detecting a power failure of an alternating current (AC) source is provided. In the power failure detection circuit of the switching source, the light emitting diode is serially connected to a control circuit of a switching element, the cathode of the light emitting diode is connected to a capacitor, and a charging current to flow into the capacitor is used as a detection current for detecting a power failure of an alternating current (AC) source. Accordingly, it is possible to reduce an average of the detection current values even though the detection current has a high peak. In addition, it is possible to reduce a total power loss by matching a detection time to a conduction time and flowing the average current of the detection current into the starting resistor without change.

What is claimed is:

1. A power failure detection circuit of a switching source, comprising:
a switching element;
a control circuit of the switching element, and
a photocoupler comprising;
a light emitting diode located at a primary side of a transformer, the light emitting diode being serially connected to the control circuit, a cathode of the light emitting diode being connected to a capacitor; and
a phototransistor located at a secondary side of the transformer, for detecting a power failure of an alternating current source, wherein a charging current flowing into the capacitor is used as a detection current for detecting the power failure of the alternate current source.

2. The power failure detection circuit according to claim 1, wherein the cathode of the light emitting diode is connected to the control circuit of the switching element via a starting element.

3. The power failure detection circuit according to claim 2, wherein the starting element is a resistor.

4. The power failure detection circuit according to claim 2, wherein the starting element is a constant current circuit or a constant current element.
